(19) United States
(12) Patent Application Publication
(10) Pub. No.: US 2025/0219276 A1
(43) Pub. Date: Jul. 3, 2025

(54) FILTER FOR COMMUNICATION DEVICE AND MANUFACTURING METHOD THEREFOR

(71) Applicant: KMW INC., Hwaseong-si (KR)

(72) Inventors: Joung Hoe KIM, Hwaseong-si (KR); Sang Yoong KIM, Hwaseong-si (KR)

(73) Assignee: KMW INC., Hwaseong-si (KR)

(21) Appl. No.: 19/079,560

(22) Filed: Mar. 14, 2025

Related U.S. Application Data
(63) Continuation of application No. PCT/KR2023/013773, filed on Sep. 14, 2023.

(30) Foreign Application Priority Data
Sep. 16, 2022 (KR) 10-2022-0116995
Sep. 13, 2023 (KR) 10-2023-0121563

(51) Int. Cl. H01P 1/207; H01P 11/00

(52) U.S. Cl. CPC H01P 1/207; H01P 11/007

(57) ABSTRACT

The present invention relates to a filter for a communication device and a manufacturing method therefor, and, particularly, the filter comprises a single base plate, which is provided as a conductive board with a predetermined thickness or less that forms an inner side surface of a cavity for performing frequency filtering, wherein the cavity is formed by folding at least a portion of the base plate, and thus manufacturing is facilitated and overall slimming and lightening of a product can be sought.

### TECHNICAL FIELD

The present disclosure relates to a filter for a communication device and a method of manufacturing the same, and more particularly, to a filter for a communication device, which can minimize an insertion loss attributable to a process of coupling a structure (e.g., a resonator panel including a plurality of resonators) within a cavity, facilitate manufacturing, and manufacture a slim antenna device product in a thickness direction thereof by integrally manufacturing the components of a single base material plate in a way to be foldable, and a method of manufacturing the same.

### BACKGROUND ART

In general, a wireless frequency device (also including a “communication device”), such as a radio frequency filter, has a structure in which multiple resonators are connected. Such a resonator is a circuit element that resonates in a specific frequency by a combination of an inductor L and a capacitor C in an equivalent electronic-circuit way. Each resonator has a structure in which a dielectric resonance (DR) element or a metal resonance element is installed within a metallic cylinder or a cavity, such as a rectangular parallelepiped, which is surrounded by a conductor. Accordingly, each resonator has a structure that enables the resonance of a high frequency because only an electromagnetic field having a unique frequency according to a processing frequency band within a corresponding cavity is present. In general, each resonator has a multi-stage structure in which multiple resonant stages are formed by using multiple cavities and the multiple resonant stages are sequentially connected.

An example relating to a radio frequency filter having multiple cavity structures may include an example disclosed in Korean Patent Application Publication No. 10-2004-0100084 (entitled “RADIO FREQUENCY FILTER”, laid open on Dec. 2, 2004) that was early applied by the applicant of the present disclosure.

However, the conventional radio frequency filter is provided so that each resonator extends in a thickness direction thereof within a cavity, a part of a filter tuning cover that covers the cavity is modified by using an engraving method in order to achieve a desired bandpass characteristic, and a frequency is tuned by adjusting a distance between the resonators. The conventional radio frequency filter faces significant limitations when it comes to reducing the thickness direction of the completed filter.

Furthermore, the conventional radio frequency filter requires the installation of an additional component of a conductor material in order to implement inductive coupling or capacitive coupling so as to enhance a skirt characteristic between adjacent resonators or spaced resonators within multiple cavities. There is a problem in that the weight of a completed filter is greatly increased.

Meanwhile, recently, in an antenna device to which a massive multiple input multiple output (MIMO) technology has been applied, for the slimness manufacturing of the entire product, research is in progress in order to minimize the thickness of an internal component, such as a filter. To this end, the type of filter that is most frequently used may include a dielectric ceramic filter.

However, the dielectric ceramic filter has a problem in that the use of both surfaces of a printed circuit board (PCB) is limited in that the dielectric ceramic filter is directly closely attached and coupled to one surface of a main board (or a PA board) stacked within an antenna housing part due to the nature of its material.

### DISCLOSURE

### Technical Problem

The present disclosure has been contrived to solve the technical problems, and an object of the present disclosure is to provide a filter for a communication device and a method of manufacturing the same, which can reduce the amount of an insertion loss attributable to the coupling of two physical structures by minimizing a conventional bonding process for the forming of a cavity and the preparation of a structure, such as a resonator within the cavity.

Furthermore, an object of the present disclosure is to provide a filter for a communication device and a method of manufacturing the same, which can improve the reliability of product by a reinforcing the coupling stiffness of a thin base material plate having relatively small stiffness with respect to the filter that is provided in a folding way.

Technical objects of the present disclosure are not limited to the aforementioned objects, and the other objects not described above may be evidently understood from the following description by those skilled in the art.

### Technical Solution

A filter for a communication device according to an embodiment of the present disclosure includes a single base material plate that forms an inside of a cavity for performing frequency filtering and that is made of a conductive sheet material having a predetermined thickness or less. At least a part of the base material plate is folded to form the cavity.

In this case, the base material plate may include a lower body forming panel that forms a bottom of the cavity, a lower one-side thickness forming panel and a lower other-side thickness forming panel that are folded in an identical direction at one end and the other end of the lower body forming panel in the width direction of the lower body forming panel to form the part of the cavity, a frequency tuning panel folded so that the other end of the frequency tuning panel in the width direction thereof is integrally connected to the folded lower other-side thickness forming panel and one end of the frequency tuning panel in the width direction is connected to the top of the folded lower one-side thickness forming panel and including a plurality of tuning bars that forms a different single layer so that the different single layer is spaced apart from a single layer formed by a plurality of resonators at a predetermined distance within the cavity in the thickness direction of the frequency tuning panel, and an upper body forming panel having one end in the width direction thereof folded through a medium of the upper one-side thickness forming and the other end folded in the width direction through a medium of the upper other-side thickness forming panel so that the upper body forming panel is spaced apart from the plurality of tuning bars at a predetermined distance in the thickness direction of the cavity, wherein the other end of the upper body forming panel in the width direction is connected to the one end of the frequency tuning panel in the width direction and the top of the lower other-side thickness forming panel.

Furthermore, the base material plate may further include a resonator panel including the plurality of resonators that extends orthogonally to the folded lower forming panel the folded lower one-side thickness other-side thickness forming panel and forms the single layer within the cavity.

Furthermore, the resonator panel may be coupled and installed in a plurality of resonator panel installation slits formed so that the plurality of resonator panel installation slits penetrates any one of the lower one-side thickness forming panel and the lower other-side thickness forming panel through an inside and outside of the cavity.

Furthermore, the resonator panel may include a resonator connection bar that horizontally connects the plurality of resonators in the length direction of the cavity, a plurality of insertion ends provided at an external end of the resonator connection bar and inserted into the resonator panel installation slits, and resonant characteristic stages extended and formed from front ends of the plurality of resonators, respectively.

Furthermore, the plurality of insertion ends may be inserted into the plurality of resonator panel installation slits and then coupled by any one method of a brazing method and a welding method.

Furthermore, at least two of the lower body forming panel, the lower one-side thickness forming panel, the lower other-side thickness forming panel, the resonator panel, the frequency tuning panel, the upper one-side thickness forming panel, the upper other-side thickness forming panel, and the upper body forming panel may be disposed on an identical horizontal plane when fully deployed.

Furthermore, the filter may further include one-side shield panel folded by being integrally formed with one end of the lower body forming panel in the length direction thereof and having three sides connected to one end of the lower one-side thickness forming panel in a folded state in the length direction thereof, one end of the lower other-side thickness forming panel in a folded state in the length direction thereof, and one end of the frequency tuning panel in a folded state in the length direction thereof, respectively, and the other-side shield panel folded by being integrally formed with the other end of the lower body forming panel in the length direction thereof and having three sides connected to the other end of the lower one-side thickness forming panel in the folded state in the length direction thereof, the other end of the lower other-side thickness forming panel in the folded state in the length direction thereof, and the other end of the frequency tuning panel in the folded state in the length direction thereof, respectively.

Furthermore, the frequency tuning panel may be integrally formed with any one panel to which the resonator among the lower one-side thickness panel is coupled, forming panel and the lower other-side thickness forming panel.

Furthermore, the frequency tuning panel may have a rectangular shape and may be formed in a form of a frame that has an empty inside and is penetrated up and down. The plurality of tuning bars that is extended from an internal end of the frequency tuning panel on one side thereof in the width direction thereof to an internal end of the frequency tuning panel on the other side thereof in the width direction thereof and that forms the single layer in the thickness direction of the cavity may be extended and formed in the frequency tuning panel.

Furthermore, the frequency tuning panel may be extended and formed in the length in which the plurality of tuning bars overlaps the plurality of resonators provided as the different single layer, respectively, in the thickness direction of the cavity.

Furthermore, a plurality of coupling adjustment bars that is extended from the internal end of the frequency tuning panel on one side in the width direction to the internal end of the frequency tuning panel on the other side in the width direction, but forms an identical single layer along with the plurality of tuning bars between adjacent tuning bars, among the plurality of tuning bars, may be further extended and formed in the frequency tuning panel.

Furthermore, the plurality of coupling adjustment bars may be extended from the internal end of the frequency tuning panel on one side in the width direction and connected to the internal end of the frequency tuning panel on the other side in the width direction.

Furthermore, pin holes that are penetrated up and down may be formed in the lower body forming panel, the plurality of resonators, and the upper body forming panel, respectively. A support pin that penetrates each of the pin holes upon folding of the base material plate for forming the cavity may be installed.

Furthermore, the base material plate may forms a filter body having the cavity therein by a folding process, and the filter body is disposed between a PA board and an antenna board having multiple radiation elements disposed on a front surface of the antenna board. The filter further comprises an input connector part that inputs a predetermined electrical signal transmitted from the PA board to one side of the cavity, and an output connector part that receives a predetermined electrical signal transmitted from the other side of the cavity and that outputs the predetermined electrical signal to the antenna board. The output connector part may include a supporting housing that transfers, to the PA board, vertical pressure that acts when the front surface of the antenna board is stacked and coupled to the filter body without transferring the vertical pressure to the filter body.

Furthermore, the supporting housing may penetrate both front and rear parts of the cavity in the thickness direction thereof, and may be formed in a cylindrical shape in which the supporting housing has an empty inside and has a rear part connected to the front of the PA board and a front end connected to a rear of the antenna board.

Furthermore, the supporting housing is made of a stiff material having greater stiffness than the filter body.

Furthermore, the output connector part may further include a plurality of solder pins extended backward from a rear end of the supporting housing and inserted into the PA board, a ground washer part that is provided at a front end of the supporting housing and that supports a rear of the antenna board, and a coaxial connector that is provided in the empty space of the supporting housing and that electrically connects an output stage of a resonator panel including the plurality of resonators provided within the cavity and the antenna board.

Furthermore, the plurality of solder pins may be inserted into the front of the PA board and then soldered and coupled with the output connector part.

Furthermore, a board separation part that is formed between the plurality of solder pins and that separates the rear part of the filter body and the PA board at a predetermined distance may be formed at the rear end of the supporting housing.

Furthermore, the input connector part may be coupled to the front of the PA board in an SMT way when the plurality of solder pins of the output connector part is inserted into the front of the PA board.

A filter for a communication device according to another embodiment of the present disclosure includes a single base material plate that forms a cavity that is a dielectric filling space. The base material plate includes a lower body forming panel that forms a bottom of the cavity, a resonator panel including a plurality of resonators that forms a single layer within the cavity corresponding to an upper part of the lower body forming panel in the thickness direction thereof, a frequency tuning panel including a plurality of tuning bars that forms a different single layer so that the different single layer is spaced apart from a single layer formed by the plurality of resonators at a predetermined distance within the cavity in the thickness direction of the frequency tuning panel, and an upper body forming panel that is provided to cover an upper part of the frequency tuning panel and that forms the top of the cavity. The cavity is formed so that a lower one-side thickness forming panel, a lower other-side thickness forming panel, an upper one-side thickness forming panel, and an upper other-side thickness forming panel that connect the lower body forming panel, the resonator panel, the frequency tuning panel, and the upper body forming panel, respectively, in the thickness direction of the cavity through media of the lower one-side thickness forming panel, the lower other-side thickness forming panel, the upper one-side thickness forming panel, and the upper other-side thickness forming panel. At least two of the lower body forming panel, the resonator panel, the frequency tuning panel, and the upper body forming panel are disposed on an identical horizontal plane when fully deployed.

A method of manufacturing a filter for a communication device according to an embodiment of the present disclosure includes a first folding step of folding, in an identical direction, a lower one-side thickness forming panel and a lower other-side thickness forming panel that are integrally connected to one end and the other end of a lower body forming panel in the width direction thereof so that a part including a bottom of a cavity is formed, a second folding step of folding a frequency tuning panel including a plurality of tuning bars that forms a predetermined single layer in the thickness direction thereof within the cavity so that the frequency tuning panel forms a different single layer along with a plurality of resonators that extends orthogonally to the lower one-side thickness forming panel and the lower other-side thickness forming panel in the thickness direction thereof within the cavity after the first folding step, and a third folding step of folding one end of an upper body forming panel in the width direction thereof through a medium of an upper one-side thickness forming panel and folding the other end of the upper body forming panel in the width direction thereof through a medium of an upper other-side thickness forming panel so that the upper body forming panel is spaced apart from the plurality of tuning bars at a predetermined distance in the thickness direction of the cavity, but folding the other end of the upper body forming panel in the width direction thereof so that the other end of the upper body forming panel is connected to one end of the frequency tuning panel in a width direction thereof and the top of the lower other-side thickness forming panel.

### Advantageous Effects

According to the filter for a communication device and the method of manufacturing the same according to embodiments of the present disclosure, the following various effects may be accomplished.

First, there is an effect in that communication reliability is improved by reducing an insertion loss occurring due to the application of a bonding method because a conventional bonding (welding or brazing) method as a method for constructing a structure within the cavity is minimized and a simple folding process is performed.

Second, the present disclosure has an effect in that the light-weighting and slimness of a product can be improved by reducing the size of all of products of an antenna device in a thickness direction thereof because the cavity can be formed by using a thin base material plate of 3 t or less.

### DESCRIPTION OF DRAWINGS

FIG. 1 is a perspective view illustrating a filter for a communication device according to an embodiment of the present disclosure.

FIG. 2 is an exploded perspective view in which an input port part and an output port part coupled to the filter for a communication device in FIG. 1 have been separated.

FIGS. 3A and 3B are a downward exploded perspective view and upward exploded perspective view of the filter for a communication device in FIG. 1.

FIG. 4 is an exploded view illustrating a base material plate, among the components of the filter for a communication device in FIG. 1.

FIG. 5 is an internal perspective view of FIG. 1.

FIG. 6 is a cutaway perspective view taken along line A-A in FIG. 2.

FIG. 7 is a front view (a) of FIG. 1, a cross-sectional view (b) t along line B-B, and a cutaway perspective view (c).

FIG. 8 is a side view (a) of FIG. 1 and a cutaway perspective view taken along line C-C.

FIG. 9 is a perspective view illustrating a modified example of a frequency tuning panel, among the components of FIG. 1.

FIG. 10 is a lateral cross-sectional view for describing the function of a coupling adjustment bar according to a modified example, among the components of FIG. 9.

FIGS. 11A and 11B are a downward perspective view and upward perspective view of a filter body including an output connector part for reinforcing the stiffness of the base material plate in the folded state, among the components of FIG. 1.

FIGS. 12A and 12B are exploded perspective views of FIGS. 11A and 11B.

FIGS. 13 and 14 are cutaway perspective views illustrating an internal space of a cavity.

FIG. 15 is a partial cutaway perspective view illustrating a form in which a support pin is used upon folding process of the base material plate, among the components of FIG. 1.

FIG. 16 is a cross-sectional view illustrating a form in which the filter body has been coupled to a PA board.

### DESCRIPTION OF REFERENCE NUMERALS

100: filter for communication device 105: base material plate
110: lower body forming panel 120: lower other-side thickness forming panel
130: lower one-side thickness forming panel 140: frequency tuning panel
146: tuning bar 147: coupling adjustment bar
150: upper body forming panel 151: tuning hole
152: notch adjustment hole 161: upper other-side thickness forming panel
162: upper one-side thickness forming panel 180A: one-side shield panel
180B: other-side shield panel 200: resonator panel
210: resonator connection bar 220: resonator
230: resonator characteristic stage 300A, 1300A: input connector part
300B, 1300B: output connector part 400: support pin
1310B: supporting housing part 1320B: solder pin
1330B: coaxial connector 1340B: connection tool
1350B: ground washer part 1360B: board separation part

### BEST MODE

Hereinafter, a filter for a communication device and a method of manufacturing the same according to embodiments of the present disclosure are described in detail with reference to the accompanying drawings.

In adding reference numerals to the components of each drawing, it should be noted that the same components have the same reference numerals as much as possible even if they are displayed in different drawings. Furthermore, in describing embodiments of the present disclosure, when it is determined that a detailed description of the related well-known configuration or function hinders understanding of an embodiment of the present disclosure, the detailed description thereof will be omitted.

In describing components of an embodiment of the present disclosure, terms, such as a first, a second, A, B, (a), and (b), may be used. Such terms are used only to distinguish one component from another component, and the essence, order, or sequence of a corresponding component is not limited by the terms. All terms used herein, including technical or scientific terms, have the same meanings as those commonly understood by a person having ordinary knowledge in the art to which the present disclosure pertains, unless defined otherwise in the specification. Terms, such as those commonly used and defined in dictionaries, should be construed as having the same meanings as those in the context of a related technology, and are not construed as having ideal or excessively formal meanings unless explicitly defined otherwise in the specification.

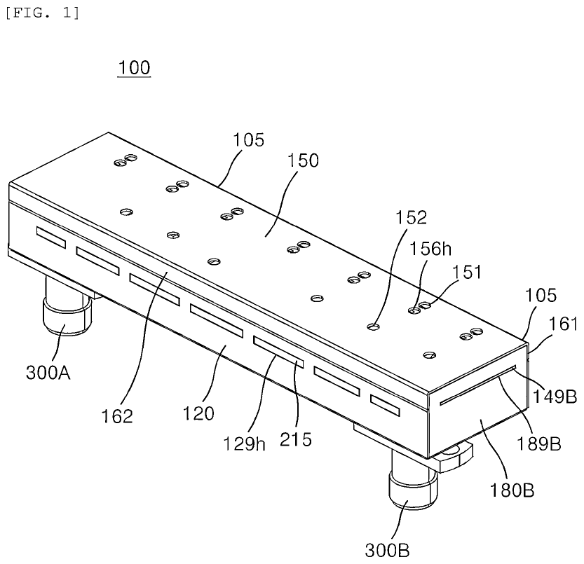

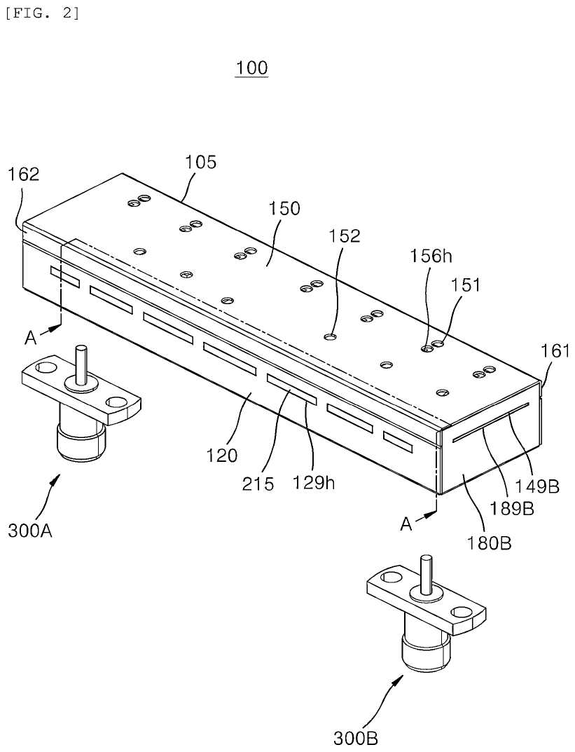

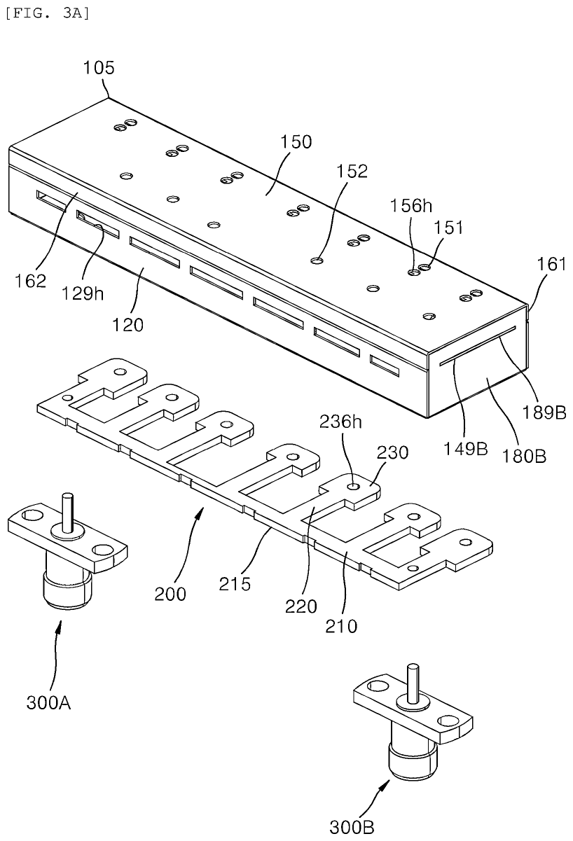

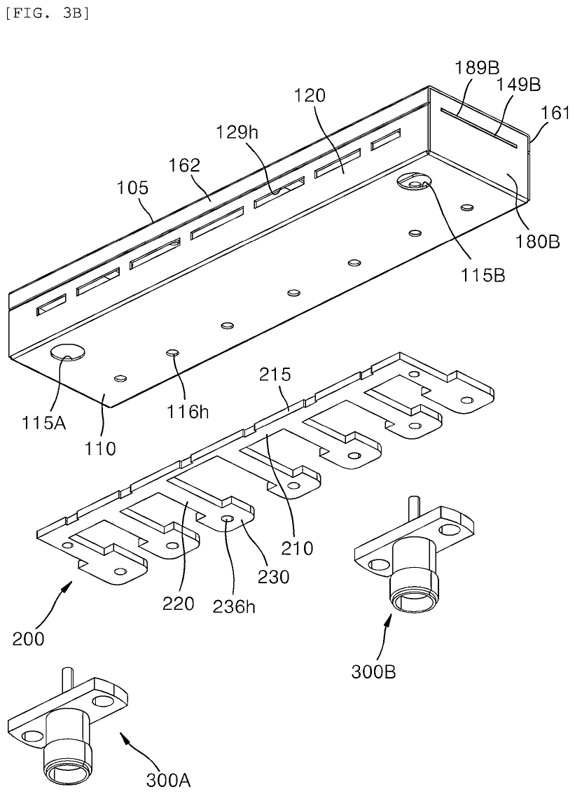

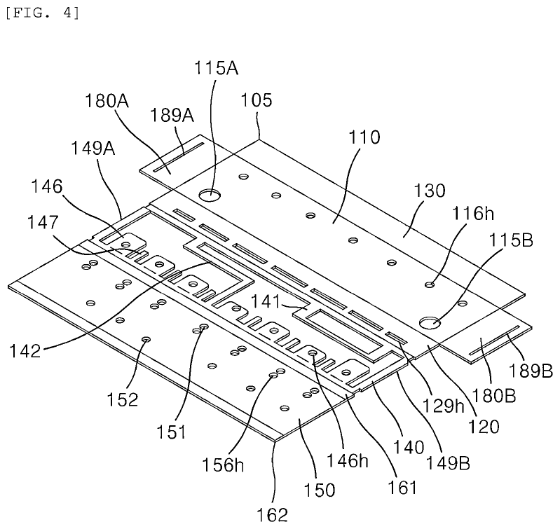

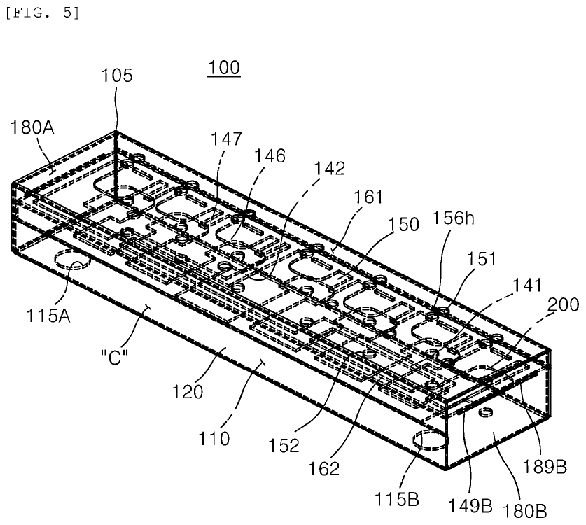

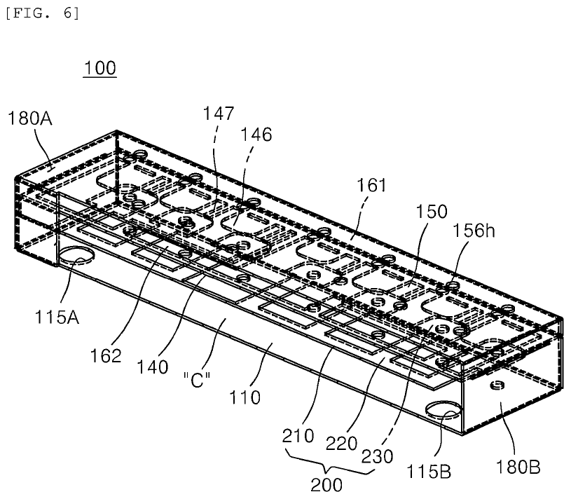

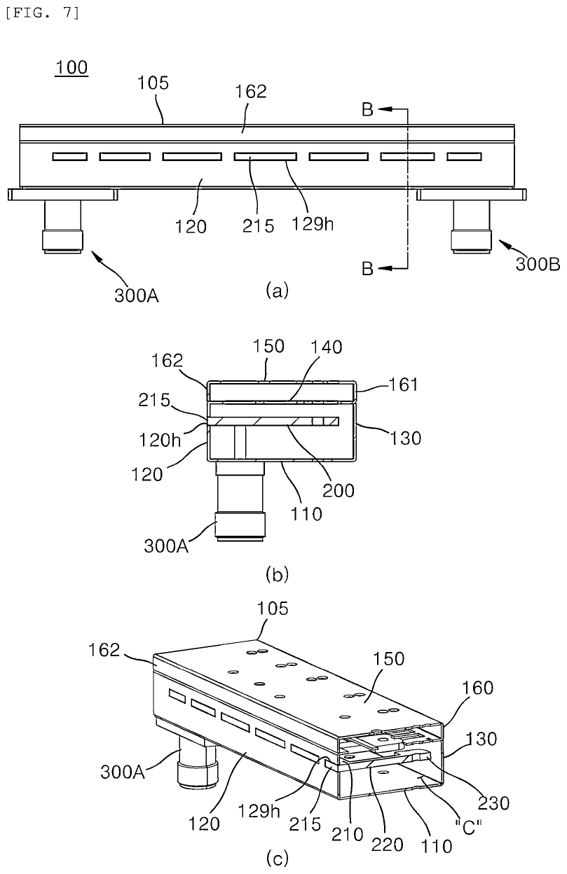

FIG. 1 is a perspective view illustrating a filter for a communication device according to an embodiment of the present disclosure. FIG. 2 is an exploded perspective view in which an input port part and an output port part coupled to the filter for a communication device in FIG. 1 have been separated. FIGS. 3A and 3B are a downward exploded perspective view and upward exploded perspective view of the filter for a communication device in FIG. 1. FIG. 4 is an exploded view illustrating a base material plate, among the components of the filter for a communication device in FIG. 1. FIG. 5 is an internal perspective view of FIG. 1. FIG. 6 is a cutaway perspective view taken along line A-A in FIG. 2. FIG. 7 is a front view (a) of FIG. 1, a cross-sectional view (b) taken along line B-B, and a cutaway perspective view (c). FIG. 8 is a side view (a) of FIG. 1 and a cutaway perspective view taken along line C-C.

In general, a filter in the antenna technology field functions to obtain only a signal desired by a consumer (user) as a result value by filtering only a signal having a specific frequency band, among signals that need to be input or output, during transmission and reception processes.

For the filtering of the signal, a cavity filter, as may be seen from its name, has a cavity, that is, a predetermined signal filtering section formed between an input port part to which a signal is input and an output port part from which a signal is output, and obtains a specific band frequency signal value of a section desired by a consumer through a frequency tuning process through the cavity.

However, so far, in the same field in which an antenna device is manufactured, in order to manufacture the cavity filter, only a method of manufacturing a cavity by processing the inside of a filter body made of a ceramic material or a material that is more stiff than the ceramic material, manufacturing essential components for frequency filtering, such as a plurality of resonators, for each product, and then fixing the components within the cavity has been disclosed.

However, a filter 100 for a communication device according to an embodiment of the present disclosure discloses a significant technical characteristic capable of minimizing the amount of an insertion loss, when a single flat base material plate not greater than a predetermined thickness is processed in a sheet plate form through a press process by breaking from the aforementioned manufacturing method and a structure (e.g., a resonator panel 200 including a plurality of resonators 220) within a cavity is then coupled through a folding process.

As referred to in FIGS. 1 to 4, the filter 100 for a communication device according to an embodiment of the present disclosure includes a base material plate 105 that is manufactured in an exploded state, but forms a cavity C therein upon folding.

In this case, the base material plate 105 may be made of a conductive sheet material that forms the inside of the cavity C, that is, a dielectric filling space for performing frequency filtering, and that has a predetermined thickness or less. In this case, it is preferred that the predetermined thickness is a thickness to the extent that the cavity can be formed through a folding process and the formed cavity can be firmly maintained, but is 3 t or less capable of preventing an increase of weight.

Meanwhile, the cavity C may be formed by an operation of folding (a folding process) at least a part of the base material plate 105.

In the filter 100 for a communication device according to an embodiment of the present disclosure, as referred to in FIGS. 1 to 4, the base material plate 105 includes a lower body forming panel 110, a lower one-side thickness forming panel 130 and a lower other-side thickness forming panel 120, a frequency tuning panel 140, and an upper body forming panel 150.

Hereinafter, terms indicative of “space” and “location” are described on the premise of the cavity C that is formed after the base material plate 105 is folded, for convenience of description. It is to be noted that before the base material plate 105 is folded, all of the aforementioned components may be formed on the same plane in a sheet metal form by a press process in an exploded form. This may be likewise applied to a filter 100 for a communication device, which is described later, according to another embodiment of the present disclosure.

More specifically, the lower body forming panel 110 is a component that forms the bottom of the cavity C after folding. One-side connector installation hole 115A and the other-side connector installation hole 115B for connecting and installing an input connector part 300A and an output connector part 300B described later may be formed to communicate with the cavity C.

The lower one-side thickness forming panel 130 and the lower other-side thickness forming panel 120 may each be orthogonally folded at the end of the lower body forming panel 110 in the width direction thereof, which is elongated in the length direction and formed in a rectangular shape, and may function to form the thickness of the cavity C on one side thereof in the width direction thereof, while forming the wall of the cavity C on one side thereof in the width direction, and to form the thickness of the cavity on the other side thereof in the width direction, while forming the wall of the cavity on the other side thereof in the width direction, respectively.

In this case, the lower one-side thickness forming panel 130 and the lower other-side thickness forming panel 120 are each formed to have a size smaller than the size of the lower body forming panel 110 in the width direction thereof. It is preferred that each of the lower one-side thickness forming panel and the lower other-side thickness forming panel is provided in a slim form in which the size of each of the lower one-side thickness forming panel and the lower other-side thickness forming panel in the thickness direction thereof is smaller than the size thereof in the width direction thereof so that a space occupied by the thickness in forward and backward directions thereof when stacked and disposed in an antenna housing part not illustrated is further reduced.

Meanwhile, the frequency tuning panel 140 may have the other end in the width direction thereof folded to be connected to the top of the folded lower one-side thickness forming panel 130. A plurality of tuning bars 146 that is spaced apart from a single layer, which is formed by the plurality of resonators 220 described later in the thickness direction of the frequency tuning panel, at a predetermined distance within the cavity C and that each forms a different layer may be formed in the frequency tuning panel.

That is, as referred to in FIG. 4, the frequency tuning panel 140 may be integrally formed to extend with respect to the lower other-side thickness forming panel 120 in an exploded state thereof, and may be orthogonally bent and folded in an inward direction in which the cavity C has been formed upon folding.

In this case, on the assumption that the frequency tuning panel 140 has a rectangular shape and is formed in the form of a square frame that is penetrated up and down and has an empty inside except the end of an edge thereof that is formed along the edge, the plurality of tuning bars 146 formed in the frequency tuning panel 140 may be formed to extend from the inside of any one of the end of the cavity C on one side thereof and the end of the cavity on the other side thereof in the width direction (the end of the cavity on one side, which is adjacent to the lower one-side thickness forming panel 130 in an embodiment of the present disclosure), may be formed to protrude in a predetermined length so that the plurality of tuning bars is horizontal toward the end of the cavity on the other side in the width direction, and may be formed to be spaced apart from each other in a predetermined length in the length direction of the cavity C.

The plurality of tuning bars 146 of the frequency tuning panel 140 may be extended and formed in the length in which the plurality of tuning bars overlaps the plurality of resonators 220 each provided as a different single layer, respectively, in the thickness direction of the cavity C.

Meanwhile, as referred to in FIG. 4, in the frequency

tuning panel 140, an L-notch part 141 that forms a notch (hereinafter referred to as an “L-notch”) by inductive coupling may be further formed at the right end (high frequency region) of a passband, and a C-notch part 142 that forms a notch (hereinafter referred to as a “C-notch”) by capacitive coupling may be further formed at the left end (low frequency region) of the passband.

The L-notch part 141 and the C-notch part 142 form the same single layer in the thickness direction of the cavity C, but may be formed to form the same single layer the plurality of tuning bars 146 previously formed in the frequency tuning panel 140. However, the L-notch part 141 and the C-notch part 142 may be provided to form the single layer different from the layer of the plurality of resonators 220 of the resonator panel 200 described later within the cavity C.

Moreover, as referred to in FIG. 4, a plurality of coupling adjustment bars 147 may each be further formed in the frequency tuning panel 140 between the plurality of tuning bars 146 that is formed within the frequency tuning panel 140 at the end of the frequency tuning panel on one side thereof in the width direction, but is spaced apart from each other at a predetermined distance in the length direction of the frequency tuning panel.

The plurality of coupling adjustment bars 147 is each disposed between the plurality of resonators 220 formed in the resonator panel 200 described later so that the shape of the coupling adjustment bar is deformed, and thus may function to adjust a coupling value between the plurality of resonators 220 that is adjacent to each other.

Meanwhile, a one-side installation rib 149A and the other-side installation rib 149B that interfere with the one-side shield panel 180A and the other-side shield panel 180B described later and that protrude outward so that the one-side installation rib and the other-side installation rib are supported in the thickness direction of the cavity C may be further formed at both ends of the frequency tuning panel 140 in the length direction thereof.

Furthermore, the upper body forming panel 150 is folded to shield the top of the cavity C against the outside, and functions to form the inside of the cavity C at an upper part thereof.

In this case, the upper body forming panel 150 may be disposed in parallel at an upper part so that the upper body forming panel is spaced apart from the frequency tuning panel 140, which is folded and disposed to form a single layer at least within the cavity C, predetermined distance.

To this end, an upper one-side thickness forming panel 161 may be integrally formed between the end of the upper body forming panel 150 on one side thereof in the width direction thereof and the frequency tuning panel 140 so that upper one-side thickness forming panel connects the end of the upper body forming panel and the frequency tuning panel. An upper other-side thickness forming panel 162 may be integrally formed at the end of the upper body forming panel 150 on the other side thereof in the width direction.

The upper one-side thickness forming panel 161 is upward folded orthogonally to the end of the frequency tuning panel 140 on one side thereof in the width direction. An upper other-side thickness forming panel 162 is downward folded orthogonally to the end of the upper body forming panel 150 on the other side thereof in the width direction. Accordingly, the bottoms of upper one-side thickness forming panel and the upper other-side thickness forming panel may be connected to the top of the lower other-side thickness forming panel 120.

Meanwhile, in the filter 100 for a communication device according to an embodiment of the present disclosure, the base material plate 105 may further include the resonator panel 200 including the plurality of resonators 220.

The resonator panel 200 is provided as a separate element, and may be coupled to the single layer formed by the plurality of tuning bars 146 of the frequency tuning panel 140, while forming a different single layer, so that the single layers are spaced apart from each other at a predetermined distance in the thickness direction thereof through the medium of a plurality of resonator panel installation slits 129h formed in any one of the lower one-side thickness forming panel 130 and lower other-side thickness forming panel 120 of the base material plate 105.

More specifically, as referred to in FIGS. 1 to 4, the resonator panel 200 may include the plurality of resonators 220 that is inward folded and extended orthogonally to the lower one-side thickness forming panel 130 and the lower other-side thickness forming panel 120 that have been folded and that forms a single layer within the cavity C.

The resonator panel 200 may be coupled and installed in the plurality of resonator panel installation slits 129h that is formed to penetrate any one of the lower one-side thickness forming and the lower other-side thickness forming panel 120 through the inside and outside of the cavity C.

In this case, as referred to in FIG. 3A, the resonator panel 200 may include a resonator connection bar 210 that horizontally connects the plurality of resonators 220 in the length direction of the cavity C, a plurality of insertion ends 215 provided at an external end of the resonator connection bar 210 and inserted into the resonator panel installation slits 129h, and resonant characteristic stages 230 extended and formed at the front ends of the plurality of resonators 220, respectively.

Meanwhile, the plurality of insertion ends 215 provided at the external end of the resonator connection bar 210 may be inserted into the plurality of resonator panel installation slits 129h from an inside including the cavity C and then coupled buy using any one method of a brazing method and a welding method.

In this case, as referred to in FIGS. 1 to 4, the base material plate 105 may further include the one-side shield panel 180A that is integrally formed and folded at one end of the lower body forming panel 110 in the length direction thereof, but has three sides connected to one end of the lower one-side thickness forming panel 130 in the folded state in the length direction thereof, one end of the lower other-side thickness forming panel 120 in the folded state in the length direction thereof, and one end of the frequency tuning panel 200 in the folded state in the length direction thereof, respectively, and the other-side shield panel 180B that is integrally formed and folded at the other end of the lower body forming panel 110 in the length direction thereof, but has three sides connected to the other end of the lower one-side thickness forming panel 130 in the folded state in the length direction thereof, the other end of the lower other-side thickness forming panel 120 in the folded state in the length direction thereof, and the other end of the frequency tuning panel 140 in the folded state in the length direction thereof.

Meanwhile, as referred to in FIGS. 1 to 4, one-side rib penetration slit 189A and the other-side rib penetration slit 189B into which the one-side installation rib 149A and the other-side installation rib 149B formed at both ends of the frequency tuning panel 140 in the length direction thereof are inserted may be formed in the one-side shield panel 180A and the other-side shield panel 180B.

In the filter 100 for a communication device according to an embodiment of the present disclosure, the one-side shield panel 180A and the other-side shield panel 180B have each been defined to include the three sides in that a vertical cross-sectional shape of the base material plate 105 in the folded state is formed in a rectangular (oblong) shape including a side occupied by the lower body forming panel 110, but is not limited thereto and may be understood to have a side corresponding to a vertical cross-sectional: shape formed by the cavity C. For example, if the vertical cross-sectional shape of the cavity C is a triangle, the one-side shield panel 180A and the other-side shield panel 180B may each have two sides of the triangle except the side (surface) occupied by the lower body forming panel 110.

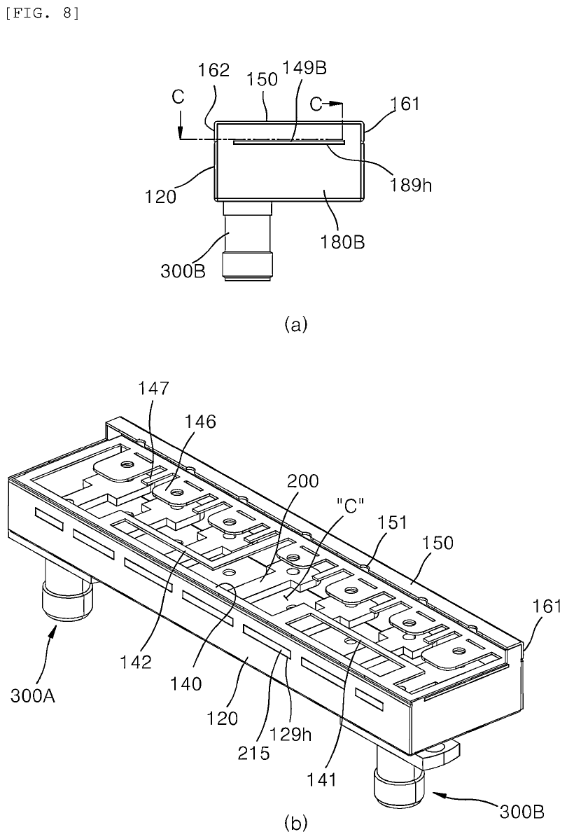

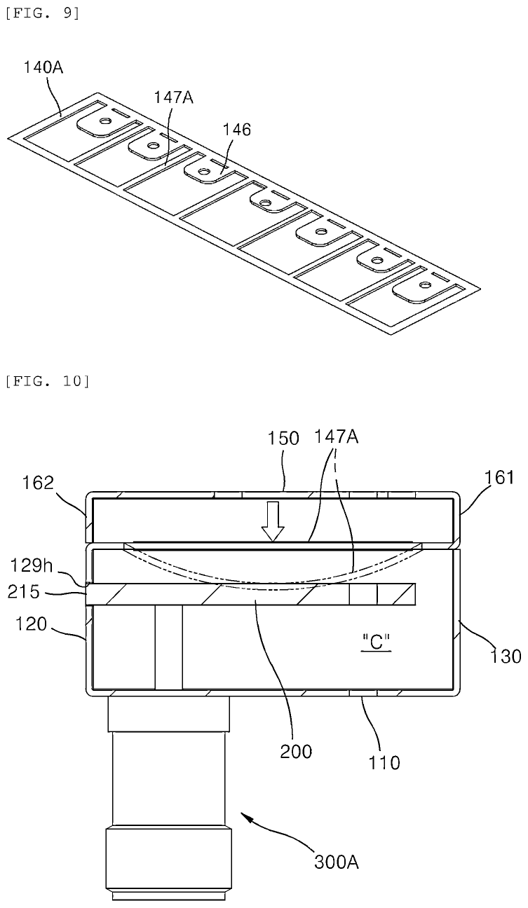

FIG. 9 is a perspective view illustrating a modified example of the frequency tuning panel, among the components of FIG. 1. FIG. 10 is a lateral cross-sectional view for describing the function the coupling adjustment bar according to a modified example, among the components of FIG. 9.

The plurality of coupling adjustment bars 147 that is each extended from an internal end of the frequency tuning panel 140 on one side thereof in the width direction thereof to an internal end of the frequency tuning panel on the other side thereof in the width direction thereof as described above, but forms the same single layer as the plurality of tuning bars 146 between adjacent tuning bars, among the plurality of tuning bars 146, may be further extended and formed in the frequency tuning panel 140.

In this case, the plurality of coupling adjustment bars 147 referred to in FIGS. 5 to 8 is each extended from the internal end of the frequency tuning panel 140 at the end thereof on one side thereof in the width direction thereof, but is each formed to be less extended than at least the front end of each of the plurality of tuning bars However, as referred to in FIGS. 9 and 10, the 146. plurality of coupling adjustment bars 147 formed in the frequency tuning panel 140 of the modified example may be provided to be extended from the internal end of the frequency tuning panel 140 at the end thereof on one side thereof in the width direction thereof and connected to the internal end of the frequency tuning panel on the other side thereof in the width direction thereof.

As referred to in FIG. 10, the coupling adjustment bar 147 of the frequency tuning panel 140 according to the modified example may perform a role of adjusting a coupling value by having a shape deformed downward over the cavity C in the thickness direction thereof and being subjected to interference between the plurality of resonators 220 that is adjacent to each other in a path along which a signal flows, by a designer who tunes a fine frequency within the cavity C.

Meanwhile, the filter 100 for a communication device according to an embodiment of the present disclosure may further include a plurality of tuning holes 151 and a plurality of notch adjustment holes 152 that are formed in the upper body forming panel 150, but are formed to communicate with the cavity C, as referred to in FIGS. 1 to 8.

The plurality of tuning holes 151 is formed at locations corresponding to the plurality of tuning bars 146 provided within the cavity C. A fine frequency can be tuned by adjusting a separation distance from the plurality of resonators 220 provided as a different single layer in a way to insert a predetermined tuning tool (not illustrated) through the plurality of tuning bars 146 and to deform the shapes of the plurality of tuning bars 146.

Furthermore, the plurality of notch adjustment holes 152 is formed at locations corresponding to the L-notch part 141 and the C-notch part 142 provided to form a single layer within the cavity C. The shape of any one of the L-notch part 141 and the C-notch part 142 may be deformed in order to implement the notch of a desired passband according to a design value by inserting a predetermined coupling adjustment tool (not illustrated) through the plurality of notch adjustment holes 152.

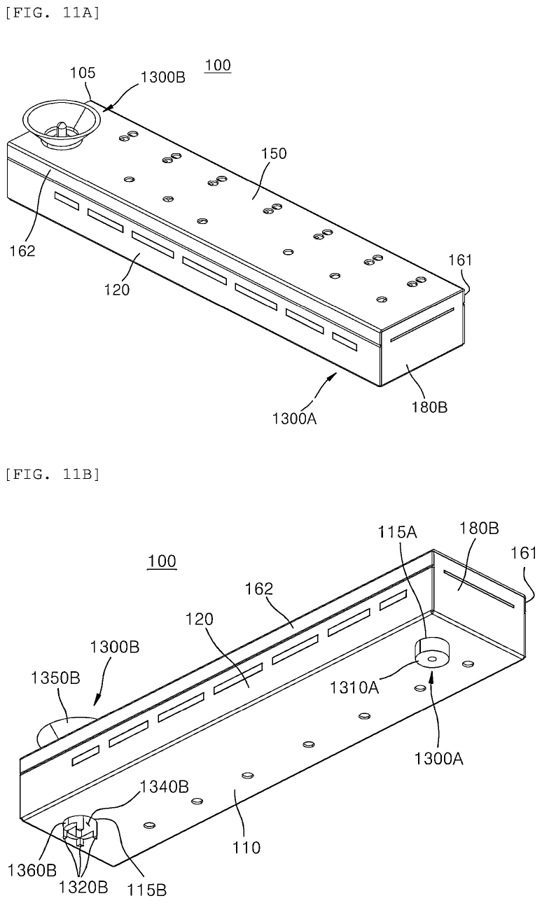

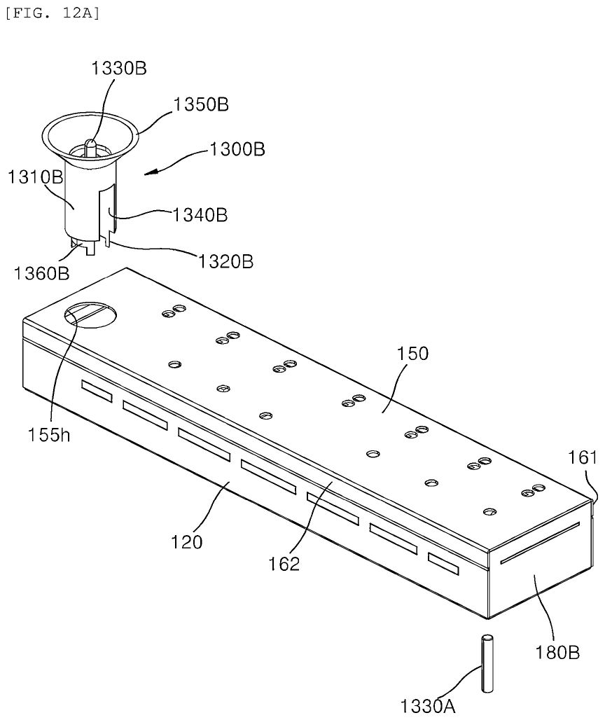

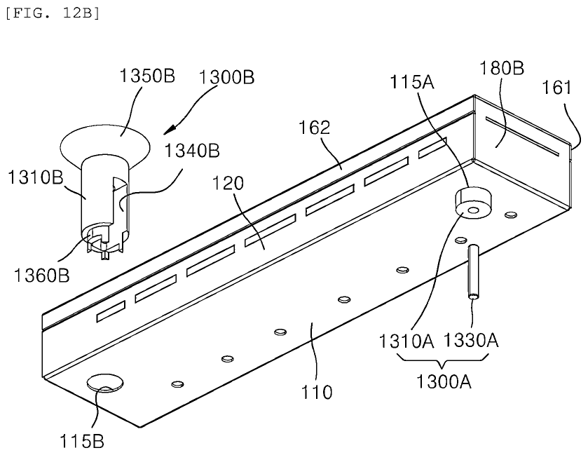

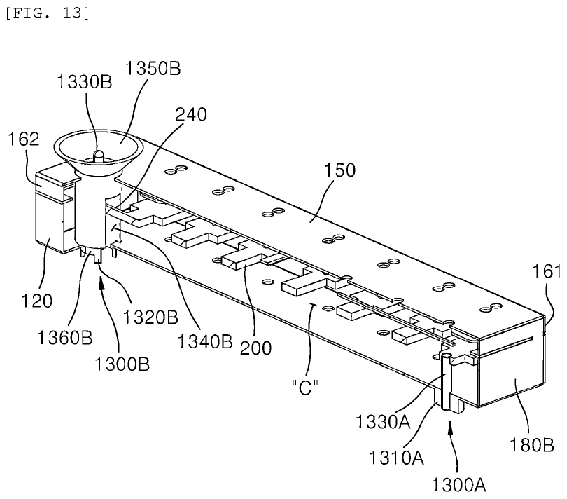

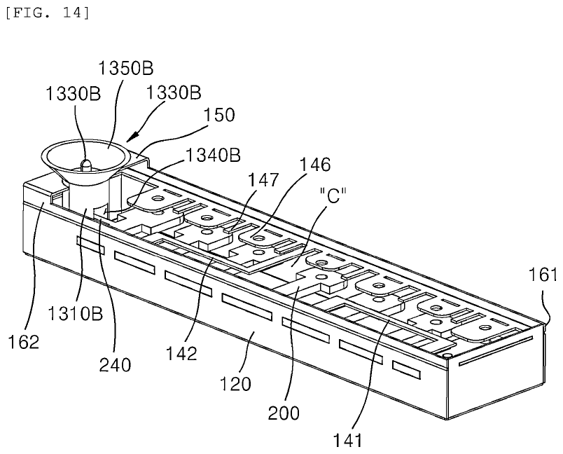

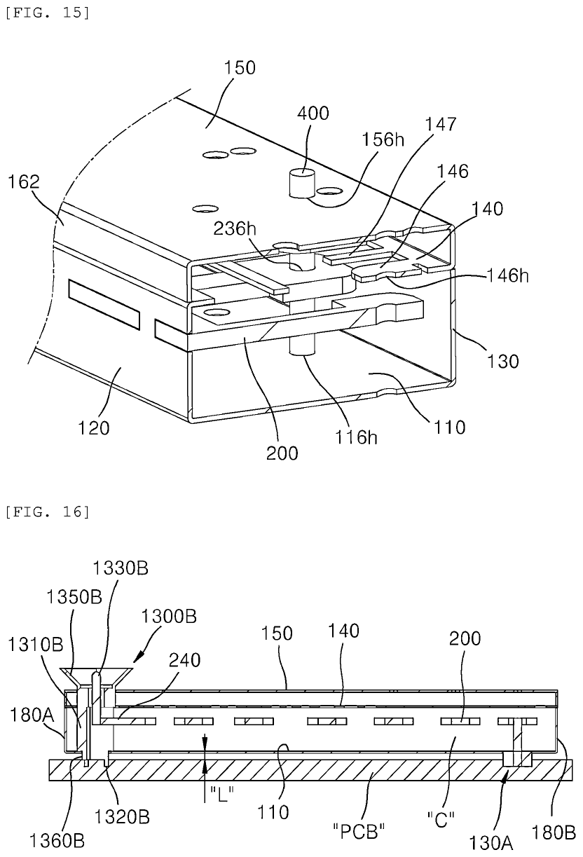

FIGS. 11A and 11B are a downward perspective view and upward perspective view of the filter body including an output connector part for reinforcing the stiffness of the base material plate in the folded state, among the components of FIG. 1. FIGS. 12A and 12B are exploded perspective views of FIGS. 11A and 11B. FIGS. 13 and 14 are cutaway perspective views illustrating an internal space of the cavity. FIG. 15 is a partial cutaway perspective view illustrating a form in which a support pin is used upon folding process of the base material plate, among the components of FIG. 1. FIG. 16 is a cross-sectional view illustrating a form in which the filter body has been coupled to a PA board.

Referring to FIGS. 11A and 11B to 16, in the filter 100 for a communication device according to an embodiment of the present disclosure, the base material plate 105 forms a filter body including the cavity C therein by a folding process. In this case, the filter body may further include an input connector part 300A, 1300A that is disposed between a PA board (PCB) and an antenna board (not illustrated) having multiple radiation elements disposed on a front surface thereof and that inputs a predetermined electrical signal transmitted from the PA board (PCB) to one side of the cavity C, and an output connector part 300B, 1300B that receives a predetermined electrical signal transmitted from the other side of the cavity C and that outputs the predetermined electrical signal to the antenna board.

As referred to in FIG. 12B, the input connector part 300A, 1300A may include a Teflon part 1310A interposed in an input connector installation hole 115A and a connecting pin 1330A that is connected to any one of the plurality of resonators 200 within the cavity C through the Teflon part 1310A.

Meanwhile, the output connector part 300B, 1300B may also be provided as the same component as the input connector part 300A, 1300A, but may be modified and installed in a form in which the transfer of an external force is minimized between the antenna board and the filter body as will be described later.

More specifically, as referred to in FIGS. 11A and 11B to 16, the output connector part 1300B may include a supporting housing 1310B that transfers, to the PA board (PCB), vertical pressure that acts when the front surface of the antenna board is stacked and coupled to the filter body of the antenna board without transferring the vertical pressure to the filter body.

The supporting housing 1310B penetrates both the front and rear parts (limited to a case in which the antenna board is disposed in the front thereof and the PA board (PCB) is disposed in the rear thereof) of the cavity C in the thickness direction thereof, and may be formed in a cylindrical shape in which the supporting housing has an empty inside and has a rear end connected to the front of the PA board (PCB) and a front end connected to the rear of the antenna board.

Furthermore, it is preferred the supporting housing 1310B is made of a stiff material having greater stiffness than the filter body.

Therefore, in stacking and coupling the antenna board to the front of the filter body, an external force that is transferred from an assembler or an automatic assembly zig (etc.) is provided to be relatively small (3 t or less) and slim and is directly transferred to the PA board (PCB) without being transferred to the filter body having weak stiffness. Accordingly, there is an advantage in that the deformation of a shape upon assembly can be prevented.

In this case, the output connector part 1300B may include a plurality of solder pins 1320B that is extended backward from the rear end of the supporting housing 1310B and inserted into the PA board (PCB), a ground washer part 1350B that is provided at the front end of the supporting housing 1310B and that supports the rear of the antenna board, and a coaxial connector 1330B that is provided in the empty space of the supporting housing 1310B and that electrically connects the output stage 240 of the resonator panel 200 including the plurality of resonators 220 provided within the cavity C and the antenna board.

The coaxial connector 1330B includes a terminal pin (a reference numeral not assigned) for an electrical connection with the antenna board. A connection tool 1340B into which the output stage 240 of the resonator panel 200 is inserted and installed may be formed in the supporting housing 1310B in a way to communicate with the supporting housing.

Meanwhile, as referred to in FIG. 16, the plurality of solder pins 1320B of the output connector part 1300B may be inserted into the front of the PA board (PCB) and then soldered and combined therewith.

In this case, as referred to in FIG. 16, a board separation part 1360B that is formed between the plurality of solder pins 1320B and that separates the rear part of the filter body and the PA board (PCB) at a predetermined distance may be formed at the rear end of the supporting housing 1310B.

Therefore, the filter body and the PA board (PCB) are spaced apart from each other (refer to reference numeral “L” in FIG. 16) by the board separation part 1360B. There can be provided an advantage in that both sides of the PA board (PCB) provided as a common PCB can be used without limitation.

Meanwhile, it is preferred that the input connector part 1300A is provided to be coupled to the front of the PA board (PCB) in an SMT way when the plurality of solder pins 1320B of the output connector part 1300B is inserted into the front of the PA board (PCB).

Meanwhile, as referred to in FIG. 15, pin holes 116h, 236h, and 156h that are penetrated up and down are formed in the lower body forming panel 110, the plurality of resonators 220, and the upper body forming panel 150, respectively. Upon folding of the base material plate 105 for forming the cavity C, a support pin 400 that penetrates the pin holes 116h, 236h, and 156h may be installed. That is, the support pin 400 does not affect frequency filtering and tuning within the cavity C because the support pin is inserted into the pin holes 116h, 236h, and 156h so that ear portion of the support pin is folded at an accurate location upon folding process and then removed when the folding process is completed.

A method of manufacturing the filter for a communication device according to an embodiment of the present disclosure is described as follows.

That is, as referred to in FIGS. 1 to 16, the method of manufacturing the filter for a communication device according to an embodiment of the present disclosure includes a first folding step of folding, in the same direction, the lower one-side thickness forming panel 130 and the lower other-side thickness forming panel 120 that are integrally connected to one end and the other end of the lower body forming panel 110 in the width direction thereof so that a part including the bottom of the cavity C is formed, a second folding step of folding the frequency tuning panel 140 including the plurality of tuning bars 146 that forms a predetermined single layer in the thickness direction thereof within the cavity C so that the frequency tuning panel forms a different single layer along with the plurality of resonators 220 that extends orthogonally to the lower one-side thickness forming panel 130 and the lower other-side thickness forming panel 120 in the thickness direction thereof within the cavity C after the first folding step, and a third folding step of folding one end of the upper body forming panel 150 in the width direction thereof through the medium of the upper one-side thickness forming panel 162 and folding the other end of the upper body forming panel 150 in the width direction thereof through the medium of the upper other-side thickness forming panel 161 so that the upper body forming panel is spaced apart from the plurality of tuning bars 146 at a predetermined distance in the thickness direction of the cavity C, but folding the other end of the upper body forming panel in the width direction thereof so that the other end of the upper body forming panel is connected to one end of the frequency tuning panel 140 in the width direction thereof and the top of the lower other-side thickness forming panel 120.

It may be seen that detailed folding processes of the remaining components may be additionally performed with reference to FIG. 4.

The filter for a communication device and the method of manufacturing the same according to embodiments of the present disclosure have been described above in detail with reference to the accompanying drawings. However, an embodiment of the present disclosure is not essentially limited to the aforementioned embodiment, and may include various modifications and implementations within an equivalent range thereof by a person having ordinary knowledge in the art to which the present disclosure pertains. Accordingly, the true range of a right of the present disclosure will be said to be defined by the appended claims.

### INDUSTRIAL APPLICABILITY

The present disclosure provides the filter for a communication device and the method of manufacturing the same, which can reduce the amount of an insertion loss attributable to the coupling of two physical structures by minimizing a conventional bonding process for the forming of a cavity and the preparation of a structure, such as a resonator within the cavity.

1. A filter for a communication device, comprising:
a single base material plate that forms an inside of a cavity for performing frequency filtering and that is made of a conductive sheet material having a predetermined thickness or less,
wherein at least a part of the base material plate is folded to form the cavity.

2. The filter of claim 1, wherein the base material plate comprises:
a lower body forming panel that forms a bottom of the cavity;
a lower one-side thickness forming panel and a lower other-side thickness forming panel that are folded in an identical direction at one end and the other end of the lower body forming panel in a width direction of the lower body forming panel to form the part of the cavity;
a frequency tuning panel folded so that the other end of the frequency tuning panel in a width direction thereof is integrally connected to the folded lower other-side thickness forming panel and one end of the frequency tuning panel in the width direction is connected to a top of the folded lower one-side thickness forming panel and comprising a plurality of tuning bars that forms a different single layer so that the different single layer is spaced apart from a single layer formed by a plurality of resonators at a predetermined distance within the cavity in a thickness direction of the frequency tuning panel; and
an upper body forming panel having one end in a width direction thereof folded through a medium of the upper one-side thickness forming panel and the other end folded in the width direction through a medium of the upper other-side thickness forming panel so that the upper body forming panel is spaced apart from the plurality of tuning bars at a predetermined distance in a thickness direction of the cavity, wherein the other end of the upper body forming panel in the width direction is connected to the one end of the frequency tuning panel in the width direction and a top of the lower other-side thickness forming panel.

3. The filter of claim 2, wherein the base material plate further comprises a resonator panel comprising the plurality of resonators that extends orthogonally to the folded lower one-side thickness forming panel and the folded lower other-side thickness forming panel and forms the single layer within the cavity.

4. The filter of claim 3, wherein the resonator panel is coupled and installed in a plurality of resonator panel installation slits formed so that the plurality of resonator panel installation slits penetrates any one of the lower one-side thickness forming panel and the lower other-side thickness forming panel through an inside and outside of the cavity.

5. The filter of claim 4, wherein the resonator panel comprises:
a resonator connection bar that horizontally connects the plurality of resonators in a length direction of the cavity;
a plurality of insertion ends provided at an external end of the resonator connection bar and inserted into the resonator panel installation slits; and
resonant characteristic stages extended and formed from front ends of the plurality of resonators, respectively.

6. The filter of claim 5, wherein the plurality of insertion ends is inserted into the plurality of resonator panel installation slits and then coupled by any one method of a brazing method and a welding method.

7. The filter of claim 2, wherein at least two of the lower body forming panel, the lower one-side thickness forming panel, the lower other-side thickness forming panel, the resonator panel, the frequency tuning panel, the upper one-side thickness forming panel, the upper other-side thickness forming panel, and the upper body forming panel are disposed on an identical horizontal plane when fully deployed.

8. The filter of claim 2, further comprising:
one-side shield panel folded by being integrally formed with one end of the lower body forming panel in a length direction thereof and having three sides connected to one end of the lower one-side thickness forming panel in a folded state in a length direction thereof, one end of the lower other-side thickness forming panel in a folded state in a length direction thereof, and one end of the frequency tuning panel in a folded state in a length direction thereof, respectively; and
the other-side shield panel folded by being integrally formed with the other end of the lower body forming panel in the length direction thereof and having three sides connected to the other end of the lower one-side thickness forming panel in the folded state in the length direction thereof, the other end of the lower other-side thickness forming panel in the folded state in the length direction thereof, and the other end of the frequency tuning panel in the folded state in the length direction thereof, respectively.

9. The filter of claim 2, wherein the frequency tuning panel is integrally formed with any one panel to which the resonator panel is coupled, among the lower one-side thickness forming panel and the lower other-side thickness forming panel.

10. The filter of claim 9, wherein:
the frequency tuning panel has a rectangular shape and is formed in a form of a frame that has an empty inside and is penetrated up and down, and
the plurality of tuning bars that is extended from an internal end of the frequency tuning panel on one side thereof in the width direction thereof to an internal end of the frequency tuning panel on the other side thereof in the width direction thereof and that forms the single layer in the thickness direction of the cavity is extended and formed in the frequency tuning panel.

11. The filter of claim 10, wherein the frequency tuning panel is extended and formed in a length in which the plurality of tuning bars overlaps the plurality of resonators provided as the different single layer, respectively, in the thickness direction of the cavity.

12. The filter of claim 10, wherein a plurality of coupling adjustment bars that is extended from the internal end of the frequency tuning panel on one side in the width direction to the internal end of the frequency tuning panel on the other side in the width direction, but forms an identical single layer along with the plurality of tuning bars between adjacent tuning bars, among the plurality of tuning bars, is further extended and formed in the frequency tuning panel.

13. The filter of claim 12, wherein the plurality of coupling adjustment bars is extended from the internal end of the frequency tuning panel on one side in the width direction and connected to the internal end of the frequency tuning panel on the other side in the width direction.

14. The filter of claim 11, wherein:
pin holes that are penetrated up and down are formed in the lower body forming panel, the plurality of resonators, and the upper body forming panel, respectively, and
a support pin that penetrates each of the pin holes upon folding of the base material plate for forming the cavity is able to be installed.

15. The filter of claim 2, wherein the base material plate forms a filter body having the cavity therein by a folding process, and the filter body is disposed between a PA board and an antenna board having multiple radiation elements disposed on a front surface of the antenna board, and
wherein the filter further comprises:
an input connector part that inputs a predetermined electrical signal transmitted from the PA board to one side of the cavity; and
an output connector part that receives a predetermined electrical signal transmitted from the other side of the cavity and that outputs the predetermined electrical signal to the antenna board,
wherein the output connector part comprises a supporting housing that transfers, to the PA board, vertical pressure that acts when the front surface of the antenna board is stacked and coupled to the filter body without transferring the vertical pressure to the filter body.

16. The filter of claim 15, wherein the supporting housing penetrates both front and rear parts of the cavity in a thickness direction thereof and is formed in a cylindrical shape in which the supporting housing has an empty inside and has a rear part connected to a front of the PA board and a front end connected to a rear of the antenna board.

17. The filter of claim 15, wherein the supporting material having greater housing is made of a stiff stiffness than the filter body.

18. The filter of claim 17, wherein the output connector part further comprises:
a plurality of solder pins extended backward from a rear end of the supporting housing and inserted into the PA board;
a ground washer part that is provided at a front end of the supporting housing and that supports a rear of the antenna board; and
a coaxial connector that is provided in the empty space of the supporting housing and that electrically connects an output stage of a resonator panel comprising the plurality of resonators provided within the cavity and the antenna board.

19. The filter of claim 18, wherein the plurality of solder pins is inserted into a front of the PA board and then soldered and coupled with the output connector part.

20. The filter of claim 18, wherein a board separation part that is formed between the plurality of solder pins and that separates the rear part of the filter body and the PA board at a predetermined distance is formed at the rear end of the supporting housing.

21. The filter of claim 18, wherein the input connector part is coupled to a front of the PA board in an SMT way when the plurality of solder pins of the output connector part is inserted into the front of the PA board.

22. A filter for a communication device, comprising:
a single base material plate that forms a cavity that is a dielectric filling space,
wherein the base material plate comprises:
a lower body forming panel that forms a bottom of the cavity;
a resonator panel of comprising a plurality resonators that forms a single layer within the cavity corresponding to an upper part of the lower body forming panel in a thickness direction thereof;
a frequency tuning panel comprising a plurality of tuning bars that forms a different single layer so that the different single layer is spaced apart from a single layer formed by the plurality of resonators at a predetermined distance within the cavity in a thickness direction of the frequency tuning panel; and
an upper body forming panel that is provided to cover an upper part of the frequency tuning panel and that forms a top of the cavity,
wherein the cavity is formed so that a lower one-side thickness forming panel, a lower other-side thickness forming panel, an upper one-side thickness forming panel, and an upper other-side thickness forming panel that connect the lower body forming panel, the resonator panel, the frequency tuning panel, and the upper body forming panel, respectively, in a thickness direction of the cavity through media of the lower one-side thickness forming panel, the lower other-side thickness forming panel, the upper one-side thickness forming panel, and the upper other-side thickness forming panel, and
at least two of the lower body forming panel, the resonator panel, the frequency tuning panel, and the upper body forming panel are disposed on an identical horizontal plane when fully deployed.

23. A method of manufacturing a filter for a communication device, the method comprising:
a first folding step of folding, in an identical direction, a lower one-side thickness forming panel and a lower other-side thickness forming panel that are integrally connected to one end and the other end of a lower body forming panel in a width direction thereof so that a part comprising a bottom of a cavity is formed;
a second folding step of folding a frequency tuning panel comprising a plurality of tuning bars that forms a predetermined single layer in a thickness direction thereof within the cavity so that the frequency tuning panel forms a different single layer along with a plurality of resonators that extends orthogonally to the lower one-side thickness forming panel and the lower other-side thickness forming panel in a thickness direction thereof within the cavity after the first folding step; and
a third folding step of folding one end of an upper body forming panel in a width direction thereof through a medium of an upper one-side thickness forming panel and folding the other end of the upper body forming panel in the width direction thereof through a medium of an upper other-side thickness forming panel so that the upper body forming panel is spaced apart from the plurality of tuning bars at a predetermined distance in a thickness direction of the cavity, but folding the other end of the upper body forming panel in the width direction thereof so that the other end of the upper body forming panel is connected to one end of the frequency tuning panel in a width direction thereof and a top of the lower other-side thickness forming panel.
